(19) United States
(12) Patent Application Publication
(10) Pub. No.: US 2025/0164250 A1
(43) Pub. Date: May 22, 2025

(54) SYSTEMS AND METHODS FOR PRIORITIZED IMU SELECTION FOR ENHANCING INERTIAL NAVIGATION ACCURACY

(71) Applicant: The Regents of the University of California, Oakland, CA (US)

(72) Inventors: Chi-Shih Jao, Irvine, CA (US); Andrei SHKEL, Irvine, CA (US)

(73) Assignee: The Regents of the University of California, Oakland, CA (US)

(21) Appl. No.: 18/965,156

(22) Filed: Dec. 2, 2024

Related U.S. Application Data
(63) Continuation-in-part of application No. 18/950,986, filed on Nov. 18, 2024.
(60) Provisional application No. 63/600,080, filed on Nov. 17, 2023.

(51) Int. Cl. G01C 21/16

(52) U.S. Cl. CPC G01C 21/166

(57) ABSTRACT

Process and device configurations are provided for prioritized inertial measurement unit (IMU) position tracking. In one embodiment, a method is provided including receiving sensor output for a plurality of inertial measurement unit (IMU) sensors, and generating a measurement vector for output of the plurality of IMU sensors. The method can also include selecting sensor output of a first IMU sensor, wherein the sensor output for the first IMU sensor is selected using noise performance of sensor output for the first IMU sensor. The method can also include outputting a measurement vector of the first IMU sensor.

### CROSS REFERENCE TO RELATED APPLICATION

This application is a continuation in part of U.S. application Ser. No. 18/950,986 titled SYSTEMS AND METHODS FOR PRIORITIZED IMU SELECTION FOR ENHANCING INERTIAL NAVIGATION ACCURACY filed on Nov. 18, 2024, which claims priority to U.S. provisional application No. 63/600,630 titled SYSTEMS AND METHODS FOR PRIORITIZED IMU SELECTION FOR ENHANCING INERTIAL NAVIGATION ACCURACY filed on Nov. 17, 2023, the content of which is expressly incorporated by reference in its entirety.

### STATEMENT OF GOVERNMENT SUPPORT

This invention was made with Government support under Grant No. 70NANB22H073 awarded by U.S. Department of Commerce and The National Institute of Standards and Technology (NIST). The Government has certain rights in the invention.

### FIELD

The present disclosure generally relates to systems and methods of pedestrian inertial navigation with inertial measurement unit (IMU) sensors including foot mounted inertial navigation and control processes for prioritized inertial measurement unit (IMU) position tracking.

### BACKGROUND

Pedestrian navigation systems have been developed to track user position using sensors in the absence of broadcasted positioning services. Performance of these systems is dependent on sensor output. Often sensors do not accurately account for user movement due to sensor limitations or configurations for detection of a particular type of movement.

One difficulty of conventional personal navigation systems is the ability to provide performance during non-walking activities. Different activities of a user may generate forces that are beyond the sensing range or bandwidth of sensors used for walking. Zero-velocity UPdaTe (ZUPT)-aided Inertial Navigation Systems (INS) apply a zero position change during heel strike phases to aid in user tracking. Other approaches attempt to predict measurements based on measurements beyond a sensor bandwidth. Drawbacks of conventional systems include performance depending on tuning to an individual. Similarly, predicted measurements may only be relevant for measurements that do not exceed bandwidth by large margins. Insufficient measurements may lead to false or inaccurate determinations of user position.

ZUPT-aided INS frameworks include the Stance Hypothesis Optimal the Prio-IMU prototype detection (SHOE) detector described in Skog, Isaac, Peter Handel, John-Olof Nilsson, and Jouni Rantakokko. “Zero-velocity detection—An algorithm evaluation.” IEEE transactions on biomedical engineering 57, no. 11 (2010): 2657-2666.

There is a desire for improvements in detecting pedestrian tracking. There is also a desire for improving detection of pedestrian tracking for non-walking movement.

### BRIEF SUMMARY OF THE EMBODIMENTS

Disclosed and described herein are systems, methods and configurations for pedestrian navigation and position tracking. In one embodiment, a method for prioritized inertial measurement unit (IMU) position tracking includes receiving, by a control device, sensor output for a plurality of inertial measurement unit (IMU) sensors. The method also includes generating, by the control device, a measurement vector for output of the plurality of IMU sensors. The method also includes selecting, by the control device, sensor output of a first IMU sensor, wherein the sensor output for the first sensor is selected using noise performance of sensor output for the first sensor, and outputting, by the control device, a measurement vector of the first IMU sensor.

In one embodiment, the plurality of IMU sensors are each mounted to a first support structure, and wherein the first support structure is a foot wearable structure.

In one embodiment, the plurality of IMU sensors includes the first IMU sensor having a first noise performance rating and a first full scale range parameter and a second IMU sensor having a second noise performance rating and a second full scale range parameter, wherein the first noise performance rating and first full scale range parameter are different from the second noise performance rating and the second full scale range parameter.

In one embodiment, the measurement vector includes accelerometer and gyroscope readings along three axes.

In one embodiment, the measurement vector includes accelerometer parameters for true acceleration, time-varying biases and noise components and gyroscope parameters for angular velocity, time-varying biases and noise components.

In one embodiment, generating the measurement vector error includes aligning measurement vectors of the plurality of IMU sensors to a body frame of the first IMU.

In one embodiment, selecting the sensor output of the first IMU sensor is based on full-scale range and noise performance of the IMU sensor for the IMU sensor.

In one embodiment, selecting the sensor output of the first IMU sensor includes selection of a non-saturated IMU sensor accelerometer measurement.

In one embodiment, outputting the measurement vector includes output of a pedestrian navigation observable including a measurement of at least one of gait, frequency and foot movement.

In one embodiment, outputting the measurement vector includes output of accelerometer and gyroscope measurements for a non-walking activity.

Another embodiment is directed to a device configured for prioritized inertial measurement unit (IMU) position tracking. The device includes a plurality of inertial measurement units (IMUs) configured to generate inertial data, and a controller coupled to the plurality of inertial measurement units. The controller is configured to receive sensor output for a plurality of inertial measurement unit (IMU) sensors. The controller is configured to generate a measurement vector for output of the plurality of IMU sensors. The controller is also configured to select sensor output of a first IMU sensor, wherein the sensor output for the first sensor is selected using noise performance of sensor output for the first sensor, and output a measurement vector of the first IMU sensor.

Other aspects, features, and techniques will be apparent to one skilled in the relevant art in view of the following detailed description of the embodiments.

### BRIEF DESCRIPTION OF THE DRAWINGS

The application file contains at least one drawing executed in color. Copies of this patent or patent application publication with color drawing(s) will be provided by the Office upon request and payment of the necessary fee.

The features, objects, and advantages of the present disclosure will become more apparent from the detailed description set forth below when taken in conjunction with the drawings in which like reference characters identify correspondingly throughout and wherein:

FIG. 1 is a graphical representation of a device configured for prioritized inertial measurement unit (IMU) position tracking according to one or more embodiments;

FIG. 2 illustrates a process for prioritized inertial measurement unit (IMU) position tracking according to one or more embodiments;

FIG. 3 depicts a device configuration according to one or more embodiments;

FIG. 4 depicts a graphical representation of sensor characteristics according to one or more embodiments;

FIG. 5 depicts a graphical representation of profiles of accelerometer and gyroscope measurements according to one or more embodiments; and

FIG. 6 depicts a graphical representation of experimental data according to one or more embodiments.

### DETAILED DESCRIPTION OF THE EXEMPLARY EMBODIMENTS

### Overview and Terminology

One aspect of the disclosure is directed to pedestrian navigation using inertial measurement units (IMUs), and in particular systems, devices, and methods for prioritized inertial measurement unit position tracking. In one embodiment, processes and configurations are provided using a plurality of inertial measurement units (IMUs) to mitigate insufficient sensor full scale range (FSR) and/or insufficient sensor bandwidth. Operations and configurations discussed herein improve detection of user motion, including improved detection of foot motion. Embodiments provide solutions for pedestrian navigation, such as ZUPT-aided INS while performing non-walking activities. Embodiments also provide measurement of extremely large forces generated by foot motion, to provide clinical gait analysis for pedestrians.

According to embodiments, systems and processes provide a prioritizable IMU array (Prio-IMU), a systematic approach utilizing multiple different IMUs to mitigate the impact of insufficient sensor FSR and bandwidth on ZUPT-aided INS using foot-mounted IMUs. The Prio-IMU can integrate readings from multiple IMUs, each with different sensor FSRs and noise characteristics. Accordingly, measurement data of an IMU may be selected with good noise characteristics and thus, accurate positioning information. Generally, selection of an IMU with good noise characteristics comes with a trade-off of low sensor FSR and bandwidth, and vice versa. In scenarios where large accelerations or angular velocities occur, utilizing a sensor with great noise performance but insufficient FR could lead to a large navigation error, compared to a sensor with poor noise performance but sufficiently high FSR.

Systems and processes are provided to mitigate problems of sensor range or sensor bandwidth for inertial navigation systems and devices, such as foot mounted IMUs. According to embodiments, processes include operations to generate measurement vectors for a plurality of IMU sensors and selection of IMU sensor output using the generated measurement vectors. Measurement vectors of IMU sensors may be aligned such that sensor characteristic are coordinated to a body frame. Sensor output may be prioritized based on scenarios. Exemplary results are described showing navigation accuracy for pedestrian navigation observables such as heel strike being improved. Experimental data is also described with accuracy improved by around 79%.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment, certain embodiments, an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

### Exemplary Embodiments

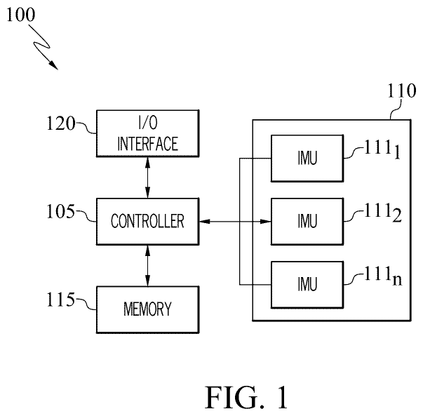

FIG. 1 is a graphical representation of device 100 configured for prioritized inertial measurement unit (IMU) position tracking according to one or more embodiments. According to embodiments, systems, methods and device configurations are provided to generate measurement vectors for a plurality of inertial measurement unit (IMU) sensors and selection of output of at least one IMU sensor. IMU sensor selection of device 100 may be performed to detect walking and/or non-walking activities. Selection of an IMU sensor may be performed to measure large forces generated by user motion, such as foot motion, to generate gait analysis and user position. Device 100 may be configured to perform one or more processes to improve generation of pedestrian movement. Embodiments provide device configurations and operations to aid and improve ZUPT-aided inertial navigation systems.

According to embodiments, device 100 may be configured to provide sensor output for one or more IMU sensors. Device 100 may relate to a wearable sensor or navigation device configured to prioritize one or more IMU sensor output. According to embodiments, device 100 includes controller 105, structure 110 including a plurality of IMU sensors 111₁₋ₙ, memory 115 and communications module 120. According to embodiments, device 100 may be used by an inertial measurement device/tracking device (e.g., mobile device, etc.).

Controller 105 may relate to a processor or control device configured to execute one or more operations stored in memory 115, such as selection and output of measurement vectors. Communications module 120 may be configured to communicate with one or more other devices, such as a mobile device, network device, or client device.

Device 100 includes structure 110, which may be a rigid body or a support structure, such as a printed circuit board with a plurality of IMU sensors, such as IMU sensors 111₁₋ₙ. Structure 100 may be worn by a user, such as on a user foot, to detect motion of the user for pedestrian navigation including walking and non-walking movement (e.g., crawling, jumping, etc.) Structure 110 may be configured to support one or more components, including controller 105 and IMU sensors 111₁₋ₙ. Structure 110 is configured to maintain spatial stability of a plurality of IMU sensors, ensuring that changes in their relative positions and orientations stay within an acceptable value such that a numerical difference induced by the spatial changes of device 100 does not exceed the errors associated with saturated accelerometer and gyroscope measurements along the three axes of detection.

According to embodiments, device 100 includes a plurality of sensors, such as IMU sensors 111₁₋ₙ. IMU sensors 111₁₋ₙ may be configured to each have different sensing characteristics, such as a different full scale range and different bandwidth for each sensor. In addition, IMU sensors 111₁₋ₙ may be mounted to different locations of structure 110. IMU sensors 111₁₋ₙ may be configured to detected acceleration and angular velocities in three directions/axes. According to embodiments, sensors mounted on structure 110 are positioned within a few centimeters of each other, allowing structure 110 to be installed on footwear without interfering with normal human gait patterns.

According to embodiments, controller 105 may be configured to receive sensor output for a plurality of IMU sensors 111₁₋ₙ. Using the sensor output, controller 105 may generate a measurement vector for output of each of IMU sensors 111₁₋ₙ. According to embodiments, controller 105 may be configured to select sensor output of a first IMU sensor of the IMU sensors 111₁₋ₙ. Selection of output for the first sensor may be based on noise performance of sensor output. The controller is also configured to select sensor output of a first IMU sensor, wherein the sensor output for the first sensor is selected using noise performance of sensor output for the first sensor, and output a measurement vector of the first IMU sensor. Controller 105 may output a measurement vector of the first IMU sensor using I/O interface 120. According to embodiments, controller 105 may be configured to operate using two IMU sensors, such as IMU sensors 111₁₋₂. According to another embodiment, controller 105 may be configured to operate using three IMU sensors, such as IMU sensors 111₁₋ₙ. According to other embodiments, controller 105 may be configured to use and device 100 may include more than three IMU sensors, such as four and five sensor configurations.

According to embodiments, device 100 may be configured to operate with a pedestrian navigation systems utilizing a Zero-velocity UPdaTe (ZUPT)-aided Inertial Navigation System (INS) based on Foot-mounted Inertial Measurement Units (IMUs). Device 100 and processes described herein may provide tracking of a pedestrian/person position in a self-contained approach, allowing seamless navigation in extremely challenging conditions. Device 100 may be configured to maintain the same level of accuracy and/or provide data to maintain the level of accuracy for walking and other common pedestrian activities, such as running, crawling, or jumping. Operations described herein can allow for navigation performance in the case of non-walking activities resulting from large forces. For example, for some non-walking activities sensors may need to detect large forces (e.g., >800 m/s²). Processes and configurations can also allow for sensors to be selected without the trade-off between Commercial-Off-The-Shelf configurations. According to embodiments, IMU sensors included in device 100 have form factors sufficiently small for structure 110 to be attached to footwear. While walking at normal speed, first IMU sensor 111₁ may be configured with noise characteristics such that the ZUPT-aided INS maintains a positioning error of less than 1 meter for several minutes. Additionally, the full-scale range of IMU sensor 111₁ prevents no saturation in the sensor measurements during walking. The second or subsequent IMU sensors, including IMU sensors 111₂ and 111ₙ, may be configured to have a full-scale range sufficiently large to measure acceleration and angular velocity impulses on the foot generated by jumping, running/sprinting, or kicking. The noise characteristics of the second or subsequent IMU sensors (e.g., IMU sensors 111₂ and 111ₙ) may be configured/chosen such that stochastic errors in their measurements are orders of magnitude smaller than the error associated with saturated measurements of the first IMU sensors (e.g., IMU sensor 111₁).

According to embodiments, operations and device configurations provide solutions to insufficient FSR and bandwidth problems. Generally, operations and device configurations do not require a set of hyper parameter tuned to an individual. In addition, operations can compensate for saturated measurements when the forces are significantly larger than an IMU sensors FSR and bandwidth.

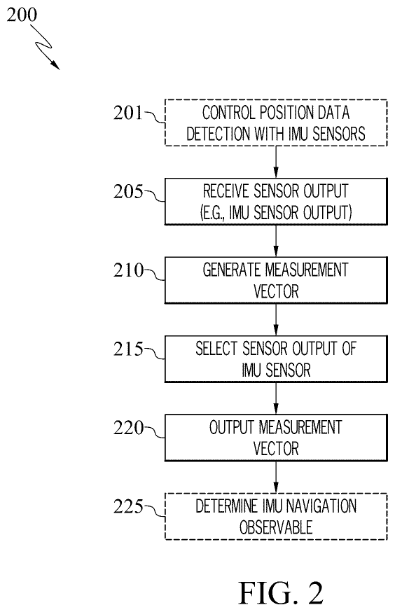

FIG. 2 illustrates a process for prioritized inertial measurement unit (IMU) position tracking according to one or more embodiments. Process 200 may be performed by a system for pedestrian navigation and one or more devices (e.g., device 100) including a plurality of IMU sensors.

Process 200 may be initiated at block 201 with optionally controlling position data detection with IMU sensors. A control device (e.g., controller 105) may be configured to initiate and/or activate one or more IMU sensors at block 201. According to embodiments, process 200 may be performed for IMU sensors having different response characteristics. By way of example, a plurality of IMU sensors controlled at block 201 of process 200 can include a first IMU sensor having a first noise performance rating and a first full scale range parameter and a second IMU sensor having a second noise performance rating and a second full scale range parameter. The first noise performance rating and first full scale range parameter are different from the second noise performance rating and the second full scale range parameter. In an example of a typical use case, first IMU sensor 111₁ may have an accelerometer white noise standard deviation, bias instability, FSR, and bandwidth of

$$230 [ \frac{μg}{\sqrt{Hz}} ] , 0.1 [ mg ] , 16 [ g ] ,$$

and 473 [Hz], respectively. First IMU sensor 111₁ may have a gyroscope white noise standard deviation, bias instability, FSR, and bandwidth of

$$0.015 [ \frac{dps}{\sqrt{Hz}} ] , 0.0019 [ dps ] , 2000 [ dps ] ,$$

and 361.4 [Hz], respectively. The second IMU sensor 111₂ has an accelerometer white noise standard deviation, bias instability, FSR, and bandwidth of

$$285 [ \frac{μg}{\sqrt{Hz}} ] , 0.15 [ mg ] , 30 [ g ] ,$$

and 473 [Hz], respectively. The second sensor has a gyroscope white noise standard deviation, bias instability, FSR, and bandwidth of

$$0.0175 [ \frac{d p s}{\sqrt{Hz}} ] , 0.0061 [ dps ] , 4000 [ dps ] ,$$

and 361.4 [Hz], respectively. The subsequent sensor 111ₙ has an accelerometer white noise standard deviation, bias instability, FSR, and bandwidth of

$$5000 [ \frac{μg}{\sqrt{Hz}} ] , 0.4 [ mg ] , 200 [ g ] ,$$

and 1600 [Hz], respectively.

At block 205, process 200 includes receiving sensor output. Receiving sensor output can include data for a plurality of inertial measurement unit (IMU) sensors. The plurality of IMU sensors may each be mounted to a first support structure, which can include a foot wearable structure. IMU sensors may be worn on a person in one or more locations including hip, leg and shin. Embodiments may be applicable to IMU sensors that are foot mounted and non-foot mounted.

At block 210, process 200 includes generating a measurement vector. Generating the measurement vector may include generating a measurement vector for output of the plurality of IMU sensors. In one embodiment, the measurement vector includes accelerometer and gyroscope readings along three axes for each sensor. In one embodiment, the measurement vector includes accelerometer parameters for true acceleration, time-varying biases and noise components, and gyroscope parameters for angular velocity, time-varying biases and noise components. In one embodiment, generating the measurement vector error includes aligning measurement vectors of the plurality of IMU sensors to a body frame of the first IMU. According to embodiments, all IMU sensors may be aligned to the body frame of the first IMU. As such, all IMU sensors included in Device 100 have been calibrated to the body frame and/or one or more measurement parameters. According to embodiments, an alignment process can be performed using two steps. For example, the first step includes estimating the translation vector and Direction Cosine Matrix (DCM) between the first IMU sensor and the others. This step first collects both stationary and non-stationary measurements from all the IMU sensors. The stationary case includes accelerometer measurements containing the gravity vector dominantly presented on each of the three axes. The non-stationary case includes both accelerometer and gyroscope measurements collected when device 100 is rotated 360 degrees several times along the three axes, where the rotation motion exceeds 200 [dps] to ensure sufficient observability in an estimation algorithm. Based on the collected data, the first step of the alignment process can use an estimation algorithm, such as the Extended Kalman Filter (EKF), documented in Skog, Isaac, et al. “Inertial sensor arrays, maximum likelihood, and cramér-rao bound.” IEEE Transactions on Signal Processing 64.16 (2016): 4218-4227, for estimation of the translation vectors and the DCMs. The second step of the alignment process aligns the coordinate systems of the second and subsequent IMU sensors with that of the first IMU sensor. For gyroscope measurements from the second and subsequent IMU sensors, the DCM estimated in the first step is applied to perform the transformation to the first IMU sensor's coordinate system. For accelerometer measurements, both the DCM and the translation vector estimated in the first step are utilized to account for centrifugal and Euler forces, ensuring the transformation aligns with the first IMU sensor's coordinate system. The angular acceleration used when compensating the Euler forces is derived by taking the difference of consecutive aligned gyroscope measurements divided by sample periods.

According to embodiments, operations of process 200 may be performed for a prioritized IMU (e.g., Prio-IMU) process and device configuration for N calibrated IMU sensors mounted on different locations of a rigid body, such as a printed circuit board (PCB). According to embodiments, IMU sensors are characterized by multiple metrics. For example, the ith IMU of the Prio-IMU may be characterized by eight metrics including accelerometer FSR, Fₐⁱ, bandwidth Bₐⁱ, Velocity Random Walk (VRW) σ_{a,N}ⁱ, and bias instability σ_{a,B}ⁱ, and gyroscopes FSR F_{g}ⁱ, bandwidth Bₐ^{j}, Angular Random Walk (ARW) σ_{g}ⁱ, and bias instability σ_{g,N}ⁱ. According to embodiments, one or more of the aforementioned metrics may be used to select an IMU. The N IMUS may be chosen such that characteristic metrics satisfy the following conditions:

$$∀ i > 0 and i < j < N , {F}_{a}^{i} \leq {F}_{a}^{j} , {B}_{a}^{i} \leq {B}_{a}^{j} , {σ}_{a , N}^{i} \leq {σ}_{a , N}^{j} , {σ}_{a , B}^{i} \leq {σ}_{a , B}^{j} ,$$

$${F}_{g}^{i} \leq {F}_{g}^{j} , {B}_{g}^{i} \leq {B}_{g}^{j} , {σ}_{g , N}^{i} \leq {σ}_{g , N}^{j} , {σ}_{g , B}^{i} \leq {σ}_{g , B}^{j} .$$

According to embodiments, the Prio-IMU produces a single measurement vector at time k, denoted as uₖ, by prioritizing the measurements collected by one of the IMUS integrated in the system. A Prio-IMU measurement vector uₖ includes accelerometer readings and gyroscope readings along the three axes. aₖ and wₖ are modeled as:

$${a}_{k} = {\overline{a}}_{k} + {\overline{b}}_{a , k} + {n}_{a , k} , {ω}_{k} = {\overline{ω}}_{k} + {\overline{b}}_{g , k} + {n}_{g , k} ,$$

where āₖ and w̅ₖ are true accelerations and angular velocities that are not measureable, b̅_{a,k} and b̅_{g,k} are unknown accelerometer and gyroscope time time-varying stochastic biases, n_{a,k} and n_{g,k} are accelerometer and gyroscope white noise components, modeled as zero-mean Gaussian with standard deviations of σ_{a,N,k} and σ_{g,N,k}, respectively.

According to the embodiments, the measurement vector may be denoted as uₖⁱⁱ for the ith calibrated IMU at time k and expressed in the sensor's own body frame. uₖⁱⁱ=[aₖⁱⁱ+ωₖⁱⁱ]^{T}, where aₖⁱⁱ and ωₖⁱⁱ represent accelerometer and gyroscope readings along the three axes, respectively. The acceleration and angular velocity measurement by the ith IMU can also be expressed in the body frame of the jth IMU, denoted as uₖ^{ij}=[aₖ^{ij}+ωₖ^{ij}]^{T}. Angular rates of ωₖⁱⁱ and ωₖ^{ij} have the following relationships

$${ω}_{k}^{ij} = {T}_{i}^{j} {ω}_{k}^{i i} ,$$

where Tᵢ^{j} is the Direct Cosine Matric (DCM) transforming the body frame of the ith IMU to the body frame of the jth IMU. Acceleration of the aₖⁱⁱ and aₖ^{ij} have the following relationship:

$${a}_{k}^{i j} = {T}_{i}^{j} {a}_{k}^{i i} + {[ {ω}_{k}^{i i} ]}_{\times } ( {[ {ω}_{k}^{i j} ]}_{\times } {r}_{i}^{j} ) + {[ {\dot{ω}}_{k}^{ij} ]}_{\times } {r}_{i}^{j} ,$$

where ωₖⁱⁱ is the angular acceleration, [ωₖ^{ij}]ₓ represents the skew-symmetric matrix a vector x, and rᵢ^{j} represents the position of the ith IMU in the body frame of the jth IMU. The terms [ωₖ^{ij}]ₓ([ωₖ^{ij}]ₓrᵢ^{j}) and ([\dot{ω}ₖ^{ij}]ₓrᵢ^{j} correspond to the centrifugal force and the Euler force, respectively. The DCM Tᵢ^{j} and the position vector rᵢ^{j} are unknown and assumed to be time-independent values.

According to embodiments, process 200 can include determining the relative geometry Tᵢ^{j} and rᵢ^{j} between two IMUs by following arrays, maximum likelihood and cramer-rao bound. The angular acceleration \dot{ω}ₖ^{ij} is calculated by taking the difference between two consecutive gyroscope measurements. That is, \dot{ω}ₖ^{ij}=ωₖ^{ij}−ω_{K-1}^{ij}/dt, where dt is the sampling rate of the IMU. According to embodiments, all IMUs area aligned to the body frame of the 1st IMU, which has the best noise performance and lowest FSR and bandwidth.

According to embodiments, at time k, the reported Prio-IMU chooses the accelerometer measurement collected by the IMU with the best noise performance among the IMUs that do not have saturated accelerometer measurements. An example of the noise performance is described in paragraph [0043] describing process 200. According to embodiments, noise performance of the IMUs may be evaluated by a controller determining a white noise component characteristic. The accelerometer white noise component n_{a,k} follows the noise characteristic of the chosen IMU. The selection may be based on

$${a}_{k} = {a}_{k}^{n 1} , {σ}_{a , N , k} = {σ}_{a , N}^{n} ,$$

$$where$$

$$n = min \{ j \vert ∀ 1 \leq i < j \leq N , \vert {a}_{k}^{i 1} \vert \geq {F}_{a}^{i} and \vert {a}_{k}^{i 1} \vert < {F}_{a}^{i} \} .$$

With the nth IMU being chosen, process 200 also estimates the time-varying accelerometer biases b̅_{a,k}. The estimated bias, denoted as b_{a,k}, is updated at each time step as

$${b}_{a , k} = {b}_{a , k}^{n 1} ,$$

where b_{a,k}^{ij} represents the estimated accelerometer stochastic time-varying bias of the ith IMU expressed in the body frame of the jth IMU. In the Prio-IMU, the stochastic biases b_{a,k}^{ij} of the accelerometer of the ith IMU are estimated based on unsaturated accelerometer measurements collected by the IMU with the best noise performance. At each timestamp k, b_{a,k}^{ij} is estimated as follows:

$${b}_{a , k}^{ij} = {a}_{k - 1}^{ij} - {a}_{k - 1}^{lj} - {b}_{a , k - 1}^{lj} ,$$

where the lth IMU is chosen such that

$$l = min \{ m \vert ∀ 1 \leq m \leq i , \vert {a}_{k - 1}^{mm} \vert \leq {F}_{a}^{m} \} .$$

The gyroscope readings of the reported Prio-IMU, ωₖ, are obtained with procedures similar to the ones associated with accelerometers as described herein. By way of example, a measurement vector may be collected from each of the IMUs and expressed as the sensor's own body frame, the IMU providing a gyroscope parameter and/or data with the best noise performance among the IMUs is selected and biases of the selected IMU are estimated.

At block 215, process 200 includes selecting sensor output of a measurement vector. Selecting sensor output of a first IMU sensor, wherein the sensor output for the first sensor is selected using noise performance of sensor output for the first sensor. In one embodiment, selecting the sensor output of the first IMU sensor is based on full-scale range and noise performance of the IMU sensor for the IMU sensor. In one embodiment, selecting the sensor output of the first IMU sensor includes selection of a non-saturated IMU sensor accelerometer measurement.

At block 220, process 200 includes outputting a measurement vector. The measurement vector of the selected IMU sensor, first IMU sensor, may be output as measurement data for determining position. At block 225, process 200 may optionally include determining an IMU navigation observable. By way of example, outputting the measurement vector can include output of a pedestrian navigation observable including a measurement of at least one of gait, frequency and foot movement. In one embodiment, outputting the measurement vector includes output of accelerometer and gyroscope measurements for a non-walking activity, such as one or more of crawling, lateral movement, mixed movement patterns and non-walking in general.

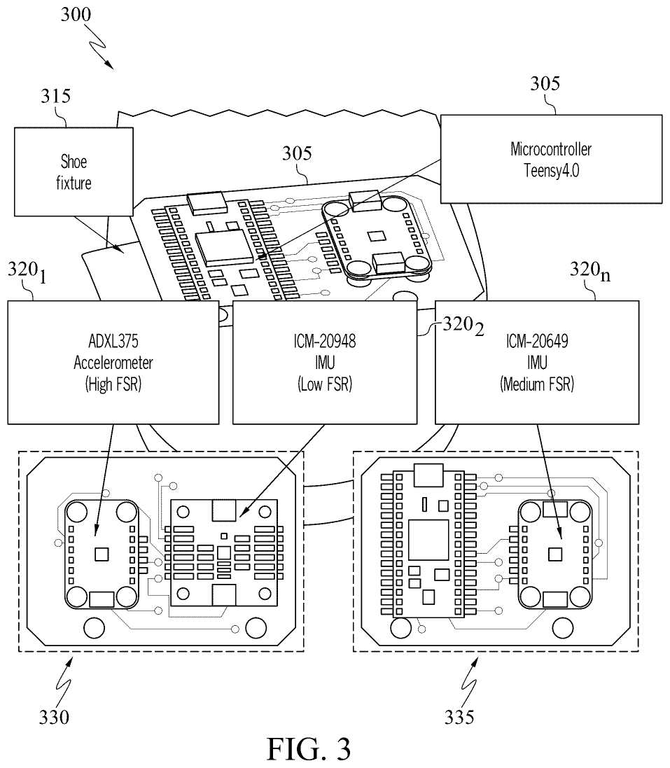

FIG. 3 depicts a device configuration according to one or more embodiments. Device 300 may relate to prototype configuration of a device or components of a device configured for prioritized inertial measurement unit (IMU) position tracking. Device 300 may include exemplary elements of device 100 of FIG. 1. According to embodiments, device 300 includes printed circuit board 305, microcontroller 310, a support structure 315 labeled as a shoe fixture and a plurality of IMU sensors 320₁₋ₙ. FIG. 3 shows IMU sensor 320₁ and IMU sensor 320₂ mounted to a back side 330 of printed circuit board 305 and IMU sensor 320ₙ mounted to a front side 330 of printed circuit board 305. According to embodiments, mounting locations may be adjusted based on IMU FSR and bandwidth. In a realization including IMU sensors capable of measuring acceleration shock larger than 2000 [m/s\hat{ }2] and gyroscope impulse of 4000 [dps], device 100 can be mounted on the heel side of footwear to achieve an optimized performance of ZUPT-aided INS algorithm. In the other realizations, device 100 may be mounted on the toe side of the footwear to minimize the possibility of collecting saturated measurements.

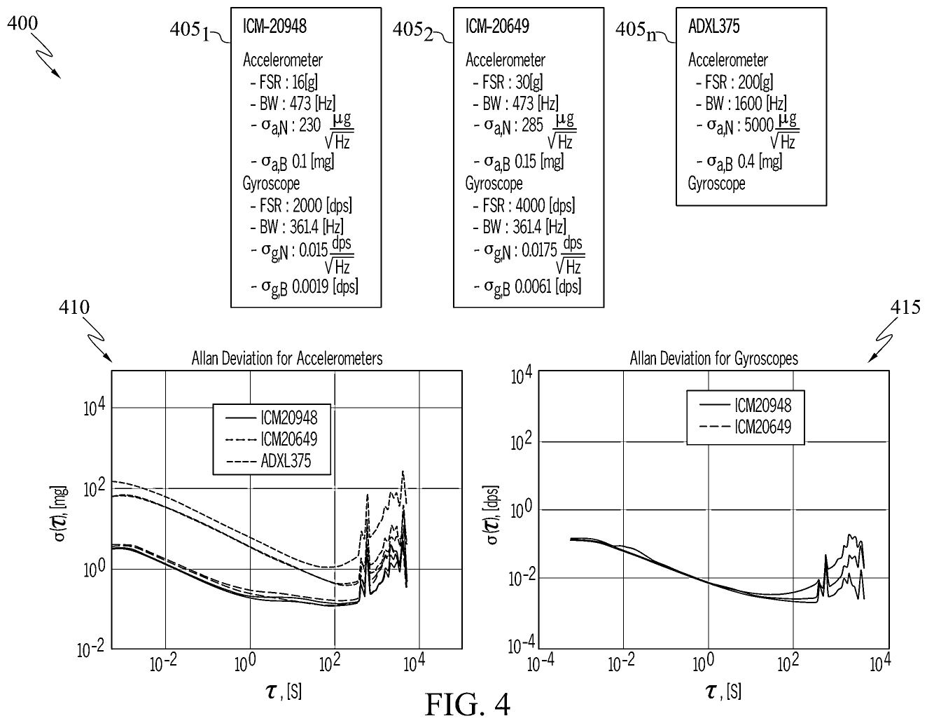

According to embodiments, device 300 includes a Teensy 4.0 microcontroller as microcontroller 310 with an ICM-20948 6-Degree of Freedom (DoF) IMU 320₂, an ICM-20649 6-DoF IMU 320ₙ, and a 3-DoF ADXL375 accelerometer 320₁. Serial Peripheral Interface (SPI) communication protocol was used to communicate with all three sensors, and the sampling rate of the system was programmed at 1800 [Hz]. Experimental characterization the three sensors, and the characteristics and the Allan deviation plots of each sensor are shown in FIG. 4.

FIG. 4 depicts a graphical representation of sensor characteristics according to one or more embodiments. Sensor characteristics 400 include characteristics 405₁₋ₙ for sensors 320₁₋ₙ. Accelerometer deviation for sensors 320₁₋ₙ is shown as 410 and gyroscope deviation for sensors 320₁₋ₙ is shown as 415.

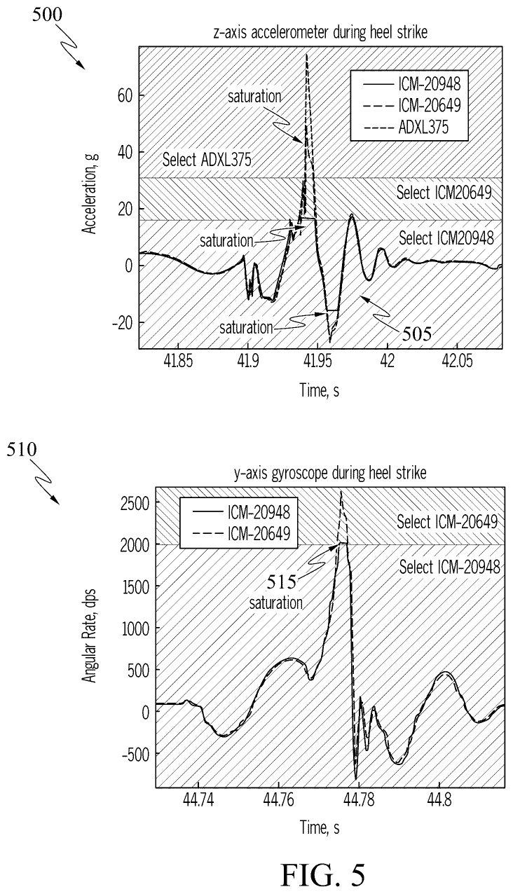

FIG. 5 depicts a graphical representation of profiles of accelerometer and gyroscope measurements according to one or more embodiments. FIG. 5 illustrates profiles of accelerometer and gyroscope measurements collected by the Prio-IMU prototype during the heel-strike phase of a running experiment. Z-axis accelerometer output during heal strike is shown as 500 and Y-axis gyroscope output during heal strike is shown as 510. Saturation of the sensors is shown as 505 for accelerometer output 500 and 515 for gyroscope output 510. As shown in FIG. 5, accelerometers of both ICM-20948 and ICM-20649 were saturated while the measurements of the ADXL375 were below the sensor accelerometer FSR of 200 [g]. Also shown in FIG. 5 is the gyroscope measurements of the ICM-20948 were saturated at 2000 [dps] while the measurements of ICM-20649 peaked at around 2600 [dps].

Collection of experimental data included for the Prio-IMU included a series of 10 sets of pedestrian indoor navigation experiments at the University of California, Irvine. In each trial, a subject first walked a straight line for around 45 [m] at a pace of around 80 [steps per minute (spm)] and then ran a straight line for 42.8 [m] at a pace of around 180 [spm]. The total trajectory length was 87.8 [m]. We compared the navigation performance of the ZUPT-aided INS using four different configurations of the Prio-IMU prototypes. Each configuration used a unique combination of the three inertial sensors shown in FIG. 3. According to embodiments, device 300 was integrated with a ZUPT-aided INS in an Extended Kalman Filter EKF) framework with the Stance Hypothesis Optimal the Prio-IMU prototype detection (SHOE). Two fixed thresholds for the SHOE detector were determined, one for the case of walking and the other for running, such that the navigation errors were minimized.

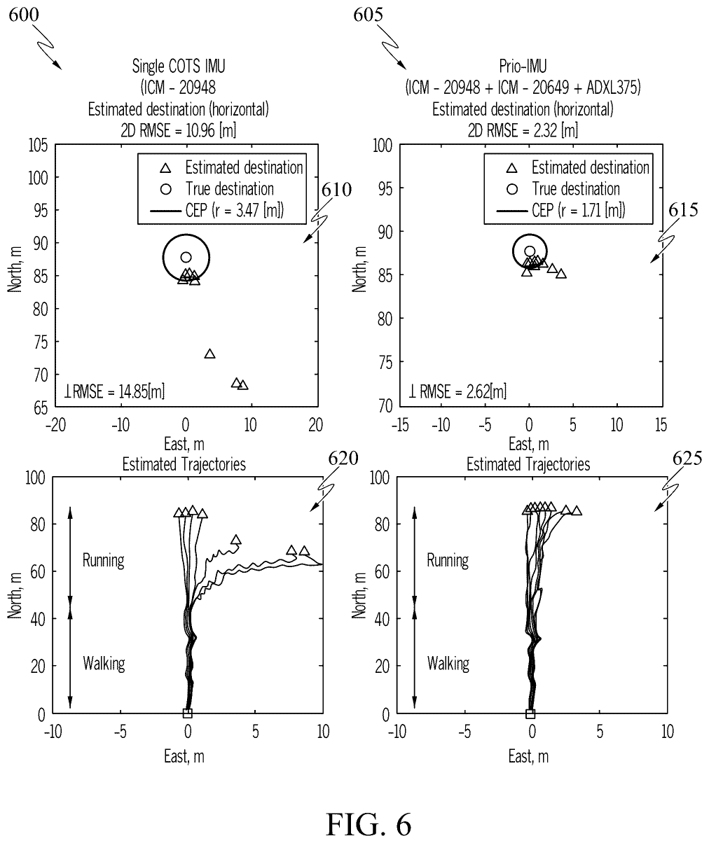

FIG. 6 depicts a graphical representation of experimental data according to one or more embodiments. FIG. 6 presents the experimental results of ZUPT-aided INS using a single COTS IMU 600 and a Prio-IMU 605 according to embodiments. The horizontal Root-Mean-Square-Errors (2D RMSEs), Circular Error Probables (CEPs), and vertical (⊥) RMSEs were used to evaluate each navigation solution, shown as 610 and 615 respectively. Estimated trajectories 620 are shown for the single COTS IMU and estimated trajectory 625 are shown for the Prio-IMU. As shown, the Prio-IMU had the minimum navigation errors, as compared to the case of using a single COTS IMU. The experimental results proved that it is beneficial to use the reported Prio-IMU to improve navigation accuracy in the case of foot-mounted IMUs.

While this disclosure has been particularly shown and described with references to exemplary embodiments thereof, it will be understood by those skilled in the art that various changes in form and details may be made therein without departing from the scope of the claimed embodiments.

What is claimed is:

1. A method for prioritized inertial measurement unit (IMU) position tracking, the method comprising:
receiving, by a control device, sensor output for a plurality of inertial measurement unit (IMU) sensors;
generating, by the control device, a measurement vector for output of the plurality of IMU sensors;
selecting, by the control device, sensor output of a first IMU sensor, wherein the sensor output for the first IMU sensor is selected using noise performance of sensor output for the first IMU sensor; and
outputting, by the control device, a measurement vector of the first IMU sensor.

2. The method of claim 1, wherein the plurality of IMU sensors are each mounted to a first support structure, and wherein the first support structure is a foot wearable structure.

3. The method of claim 1, wherein the plurality of IMU sensors includes the first IMU sensor having a first noise performance rating and a first full scale range parameter and a second IMU sensor having a second noise performance rating and a second full scale range parameter, wherein the first noise performance rating and first full scale range parameter are different from the second noise performance rating and the second full scale range parameter.

4. The method of claim 1, wherein the measurement vector includes accelerometer and gyroscope readings along three axes.

5. The method of claim 1, wherein the measurement vector includes accelerometer parameters for true acceleration, time-varying biases and noise components and gyroscope parameters for angular velocity, time-varying biases and noise components.

6. The method of claim 1, wherein generating the measurement vector error includes aligning measurement vectors of the plurality of IMU sensors to a body frame of the first IMU.

7. The method of claim 1, wherein selecting the sensor output of the first IMU sensor is based on full-scale range and noise performance of the IMU sensor for the IMU sensor.

8. The method of claim 1, wherein selecting the sensor output of the first IMU sensor includes selection of a non-saturated IMU sensor accelerometer measurement.

9. The method of claim 1, wherein outputting the measurement vector includes output of a pedestrian navigation observable including a measurement of at least one of gait, frequency and foot movement.

10. The method of claim 1, wherein outputting the measurement vector includes output of accelerometer and gyroscope measurements for a non-walking activity.

11. A device configured for prioritized inertial measurement unit (IMU) position tracking, the device comprising:
a plurality of inertial measurement units (IMUs) configured to generate inertial data; and
a controller coupled to the plurality of inertial measurement units, the controller configured to
receive sensor output for a plurality of inertial measurement unit (IMU) sensors;
generate a measurement vector for output of the plurality of IMU sensors;
select sensor output of a first IMU sensor, wherein the sensor output for the first sensor is selected using noise performance of sensor output for the first sensor; and
output a measurement vector of the first IMU sensor.

12. The device of claim 11, wherein the plurality of IMU sensors are each mounted to a first support structure, and wherein the first support structure is a foot wearable structure.

13. The device of claim 11, wherein the plurality of IMU sensors includes the first IMU sensor having a first noise performance rating and a first full scale range parameter and a second IMU sensor having a second noise performance rating and a second full scale range parameter, wherein the first noise performance rating and first full scale range parameter are different from the second noise performance rating and the second full scale range parameter.

14. The device of claim 11, wherein the measurement vector includes accelerometer and gyroscope readings along three axes.

15. The device of claim 11, wherein the measurement vector includes accelerometer parameters for true acceleration, time-varying biases and noise components and gyroscope parameters for angular velocity, time-varying biases and noise components.

16. The device of claim 11, wherein generating the measurement vector error includes aligning measurement vectors of the plurality of IMU sensors to a body frame of the first IMU.

17. The device of claim 11, wherein selecting the sensor output of the first IMU sensor is based on full-scale range and noise performance of the IMU sensor for the IMU sensor.

18. The device of claim 11, wherein selecting the sensor output of the first IMU sensor includes selection of a non-saturated IMU sensor accelerometer measurement.

19. The device of claim 11, wherein outputting the measurement vector includes output of a pedestrian navigation observable including a measurement of at least one of gait, frequency and foot movement.

20. The device of claim 11, wherein outputting the measurement vector includes output of accelerometer and gyroscope measurements for a non-walking activity.
